(19) United States
(12) Patent Application Publication
(10) Pub. No.: US 2024/0025744 A1
(43) Pub. Date: Jan. 25, 2024

(54) METHOD FOR PREPARING ULTRA CHEAP IRON PHOSPHATE

(71) Applicants: Robert Brian Huang, Las Vegas, NV (US); Richard Brian Huang, Las Vegas, NV (US)

(72) Inventors: Robert Brian Huang, Las Vegas, NV (US); Richard Brian Huang, Las Vegas, NV (US)

(73) Assignee: Watix Technology LLC, Las Vegas, NV (US)

(21) Appl. No.: 18/225,104

(22) Filed: Jul. 22, 2023

Related U.S. Application Data
(60) Provisional application No. 63/391,626, filed on Jul. 22, 2022.

(51) Int. Cl. C01B 25/37; C01B 25/26

(52) U.S. Cl. CPC C01B 25/375; C01B 25/265; C01P 2004/03; C01P 2002/74

(57) ABSTRACT

This method synthesizes low-cost, high-performance iron phosphate that can be used for producing lithium-ion battery cathodes. It has three main steps: (S1) the synthesis of a iron (II,III) phosphate solution by mixing waste iron oxide (FeO, Fe₂O₃), low purity iron powder, and sulfuric acid in an aqueous solvent, followed by the addition of phosphoric acid; (S2) the addition of hydrogen peroxide to the previous solution, followed by pH balancing chemicals to yield crude iron phosphate; and (S3) the stirring of the previous solution to precipitate iron (III) phosphate, followed by an aging step, a filtering step, a washing step, and a drying step to obtain iron phosphate, which may be in the form of a hydrate. This straightforward approach uses waste iron oxide to minimize costs, while still yielding a fairly pure iron phosphate with excellent capacity, cycling stability, and broad physical and chemical properties suitable for battery production.

### CROSS-REFERENCE TO RELATED APPLICATION

This application claims the benefit of the U.S. Provisional Patent Application No. 63/391,626, filed Jul. 22, 2022, which is incorporated by reference herein in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present invention relates to the field of chemical processing technology, in particular to methods for preparing iron phosphate.

### Description of Related Art

In recent decades, as demand for portable electronic devices have increased, lithium ion batteries have gained widespread popularity as a method of rechargeable energy storage due to their high energy density, long cycle life, and high charging/discharging efficiency.

In particular, batteries containing lithium iron phosphate (LiFePO₄) cathodes provide better capacity, voltage, volume density, high temperature stability, and energy cost basis when compared to other cathode types, such as the more commonly used lithium cobalt oxide (LiCoO₂).

In the production of lithium iron phosphate cathodes, iron (III) phosphate (FePO₄) is commonly used as raw material.

Current methods for preparing iron (III) phosphate use mostly phosphates and iron salts as base material. However, the production time and energy consumption of phosphates and iron salts to produce iron phosphate are higher than that of direct production of iron phosphate by non-salt iron compounds and phosphates. Furthermore, other by-product salts are generated from use of iron salts, resulting in either subsequent treatments that are difficult and expensive, or the resulting iron phosphate containing significant impurities. Even existing methods that use non-salt iron compounds have chosen relatively expensive iron compounds, such as high purity iron powder, which provide a good base material for the production of high purity iron phosphate, yet can strain economic feasibility. Such non-salt methods may also have unfavorable solubility products, resulting in impurities within the final iron phosphate product.

### BRIEF SUMMARY OF THE INVENTION

An aspect of the present invention provides a method for the preparation of ultra cheap iron phosphate using a three step reaction process. The sequential steps involve: (S1) the synthesis of iron (HMO phosphate solution (Fe₂(PO₄)₃, FePO₄) by mixing waste iron oxide (FeO, Fe₂O₃) and low purity iron powder (Fe) and sulfuric acid (H₂SO₄) in an aqueous solvent, followed by the addition of phosphoric acid (H₃PO₄); (S2) the addition of hydrogen peroxide (H₂O₂) to the previous solution, followed by pH balancing chemicals to yield crude iron phosphate; and (S3) the stirring of the previous solution to precipitate iron (III) phosphate (FePO₄), followed by an aging step, a filtering step, a washing step, and a drying step to obtain iron phosphate, which may be in the form of a hydrate (ex. FePO₄·H₂O, FePO₄·2H₂O, FePO₄·3H₂O, etc.).

According to the method for preparing iron phosphate of the present invention, the reaction is carried out using a non-salt iron precursor, specifically low purity iron oxide and iron powder. Despite using low purity products, the final product is high purity, and therefore is a high performance product. As well, by using low purity iron oxide and iron powder as base material, which are commonly byproducts or waste products of other iron reactions, the overall cost of the method is reduced. Finally, the presented method significantly minimizes the number and complexity of steps to reduce the cost of equipment, material, and time while still producing a product with excellent electrical conductivity, cycling stability, and comprehensive physical and chemical properties when used as the raw material to make into lithium iron phosphate cathode material for lithium iron phosphate batteries.

### BRIEF DESCRIPTION OF THE DRAWINGS

FIG. 1 illustrates a scanning electron microscope (SEM) photographic image taken at ×100000 magnification of iron phosphate prepared according to an embodiment of the present invention, indicating good crystallinity and a small average particle size.

FIG. 2 is an X-ray diffraction (XRD) pattern of the iron phosphate prepared according to an embodiment of the present invention, indicating high crystallinity and purity.

FIG. 3 is a table for various physical and chemical properties of the iron phosphate prepared according to an embodiment of the present invention.

### DETAILED DESCRIPTION OF THE INVENTION

In the present invention, a method for the preparation of ultra cheap iron phosphate using a three step reaction process is described. The preparation comprises the following steps: (S1) the synthesis of iron (KIM phosphate solution (Fe₂(PO₄)₃, FePO₄) by mixing waste iron oxide (FeO, Fe₂O₃) and low purity iron powder (Fe) and sulfuric acid (H₂SO₄) in an aqueous solvent, followed by the addition of phosphoric acid (H₃PO₄); (S2) the addition of hydrogen peroxide (H₂O₂) to the previous solution, followed by pH balancing chemicals to yield crude iron phosphate; and (S3) the stirring of the previous solution to precipitate iron (III) phosphate (FePO₄), followed by an aging step, a filtering step, a washing step, and a drying step to obtain iron phosphate, which may be in the form of a hydrate (ex. FePO₄·H₂O, FePO₄·2H₂O, FePO₄·3H₂O, etc.).

Such a method resolves the high costs brought about in prior art by using waste iron oxide as a base material and containing few and simple steps.

S1—Mixing Iron Oxide, Sulfuric Acid, and Phosphoric Acid

First, a crude chunk of low purity iron oxide (FeO, Fe₂O₃) and iron powder (Fe), and sulfuric acid (H₂SO₄) are prepared and added in an aqueous solvent. Subsequently, phosphoric acid (H₃PO₄) is prepared and added to yield a homogeneous mixture solution of iron (II,III) phosphate (Fe₃(PO₄)₂, FePO₄).

The iron oxide is preferably low purity, preferably minimizing costs of the material. Preferably, the iron oxidation states of the iron oxide are +2 or +3.

Preferably, the iron oxide is mixed with low purity iron powder at a mass ratio of 2:98-98:2. Preferably, the iron powder is 10-95 um in size.

Preferably, the mass percentage of the sulfuric acid is 20-35%. Preferably, the mixing molar ratio of the iron oxide to sulfuric acid during the formation of the mixture solution is 1:2-3.

Preferably, the mass percentage of the phosphoric acid is 20-35%.

Preferably, the mixing molar ratio of the iron oxide to phosphoric acid during the formation of the mixture solution is 1:2-3.

Preferably, step (S1) is carried out under continual rapid stirring at 40-98° C. for 0.5-3 hrs to better homogenize the solution and increase the yield of iron phosphate.

The aqueous solvent may be deionized water or another relatively pure water solution that has a high boiling point. The right amount of water makes the mass percentage content of iron in the system 2-5%.

Preferably, after step (S1), a filtering step is conducted to extract insoluble iron oxide. Then, additional phosphoric acid or aqueous solvent is added into the resulting solution to maintain a pH of 1.3-1.7. Performing this step improves the overall yield and purity of the iron phosphate by removing unreacted iron oxide.

By using low purity iron oxide and iron powder as base material, which are commonly byproducts or waste products of other iron reactions, the overall cost of the method is reduced.

S2—Addition of Hydrogen Peroxide

Second, hydrogen peroxide (H₂O₂) is added to the resulting solution from step (S1), followed by pH balancing chemicals to yield crude iron phosphate.

Preferably, the mixing molar ratio of the iron phosphate to hydrogen peroxide is 1:0.5-1.5.

Preferably, the mass percentage of the hydrogen peroxide is 20-35%.

In an embodiment, in step (S2), the pH rebalancing chemical is ammonium hydroxide (NH₄OH), sodium carbonate (Na₂CO₃), sodium bicarbonate (NaHCO₃), or a combination thereof. Preferably, pH rebalancing chemicals are added to maintain a pH of 1.3-1.5.

Preferably, step (S2) is carried out under continual rapid stirring at 40-98° C. for 0.5-3 hrs to better homogenize the solution and increase the yield of iron phosphate.

Adding hydrogen peroxide and maintaining pH levels stimulates the growth of iron phosphate crystals by creating an ideal environment for the uniform oxidation of present iron in iron phosphate to a 3+ oxidation level, thereby producing a more pure product.

S3—Synthesis Processes

The solution from step (S2) is stirred to precipitate crude iron phosphate. Subsequently, the solution is aged for 10-12 hrs and then filtered to extract iron (III) phosphate. The solid is washed with an aqueous solvent and dried in a furnace at 120-300° C. for 1-12 hrs to obtain iron (III) phosphate dihydrate (FePO₄·2H₂O).

Preferably, the solution is stirred at 400-1200 rpm at 50-80° C. for 0.5-12 hrs to better homogenize the solution and increase the yield of iron phosphate.

In an embodiment, the aqueous solvent used for washing is water or ethanol or a combination thereof. Preferably, the mass ratio of crude iron phosphate to the aqueous solvent is 1:2-4.

As described above, the presented method for preparing iron phosphate uses low purity iron oxide and iron powder as a base material, thereby reducing the overall cost of the method. The presented method removes impurities using few chemicals and steps, and produces an iron phosphate compound with relatively good physical and chemical properties. This ultimately reduces the overall cost of equipment, material, and time. Despite the low overall cost, when the produced iron phosphate is used as the raw material to make into lithium iron phosphate cathode material for lithium iron phosphate batteries, the battery has excellent electrical conductivity, cycling stability.

In order to promote the understanding of the present disclosure, the disclosure will be described below in detail, with reference to the preferred embodiment. It should be understood that the embodiment is merely illustrative, and is not intended to limit the scope of the present disclosure. Any changes, modifications and replacements made by those skilled in the art without departing from the spirit of the disclosure should fall within the scope of the disclosure defined by the claims.

(S1) 1021 g of 96% sulfuric acid was dissolved into 3947 g distilled water to obtain 5000 mL of 20% sulfuric acid and the solution was heated to 40° C. 319 g of iron oxide was added into the heated solution and the solution was stirred for 1.5 hrs. Subsequently, 1153 g of 85% phosphoric acid was dissolved into 3747 g distilled water to obtain 5000 mL of 20% phosphoric acid. The solution was then stirred for 1.5 hrs. The solution was filtered and additional phosphoric acid was added to set the pH of the resulting solution to 1.5. The primary reactions were:

Fe+H₂SO₄->FeSO₄+H₂

FeO+H₂SO₄->FeSO₄+H₂O

3Fe₂O₃+9H₂SO₄->3Fe₂(SO₄)₃+9H₂O

3FeSO₄+2H₃PO₄->Fe₃(PO₄)₂+3H₂SO₄

Fe₂(SO₄)₃+2H₃PO₄->2FePO₄+3H₂SO₄

(S2) 453 g of 30% hydrogen peroxide was added to the solution. Then, ammonium hydroxide was added into the resulting solution to set the pH of the resulting solution to 1.5. The primary reaction was:

2Fe₃(PO₄)₂+2H₃PO₄+3H₂O₂->6FePO₄+6H₂O

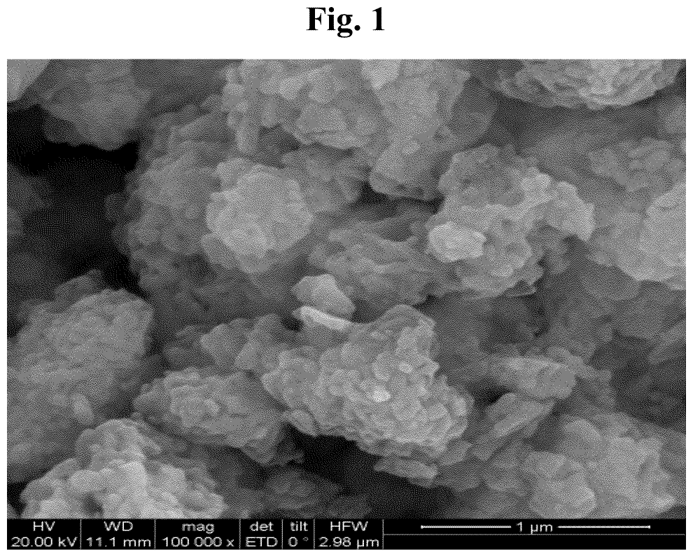

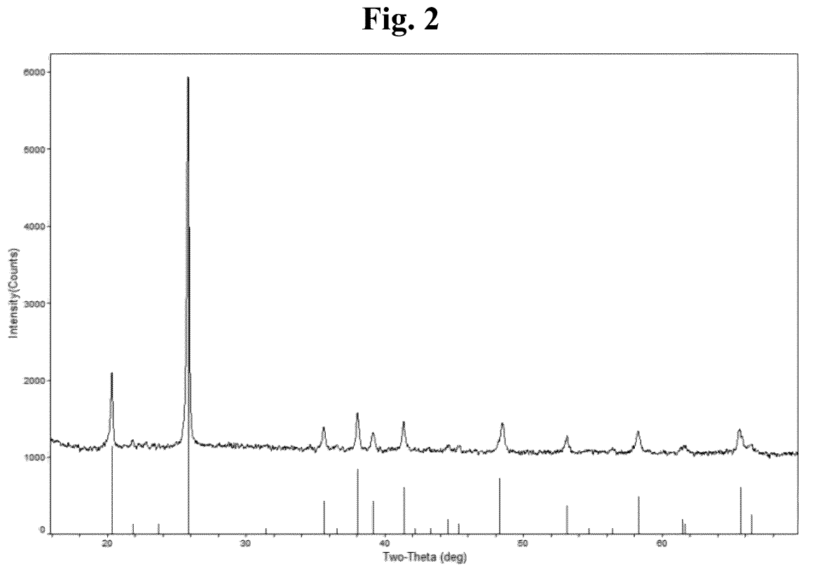

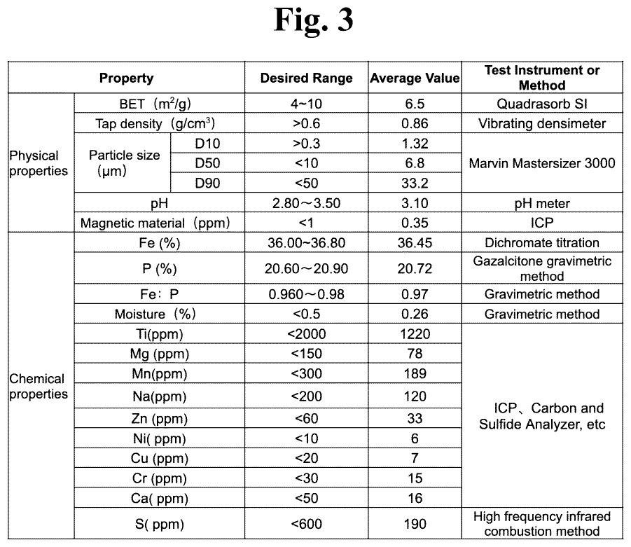

(S3) The solution was stirred at 600 rpm at 50° C. for 2 hrs. The solution was then aged for 10 hrs, and subsequently filtered to extract the iron phosphate. The product was washed with 1810 g of distilled water and dried in a furnace at 200° C. for 2 hrs. The reaction product was subsequently sifted and was analyzed with X-ray diffraction (XRD) spectroscopy and a scanning electron microscope (SEM), and was tested for multiple physical and chemical properties. FIG. 1, the SEM image, indicates good crystallinity and a small average particle size. FIG. 2, the XRD graph, indicates overall high purity. FIG. 3 corroborates that the final product demonstrates high purity and has a small average particle size, both of which are characteristics that may indicate excellent electrochemical properties.

To measure the product's performance within a battery, a lithium iron phosphate half cell was created. 71.84 g iron phosphate dihydrate (FePO₄·2H₂O), 14.8 g of lithium carbonate (Li₂CO₃), 45 g glucose (C₆O₆H₁₂), 1 g polyethylene glycol 5000 (PEG5000), 0.044 g titanium dioxide (TiO₂), and 282 g distilled water were mixed and milled to a particle size of 300 nm (D50). The milled slurry was spray dried and the resulting powder was heat treated in a furnace at 700° C. for 8 hrs under a highly pure nitrogen (N₂) atmosphere. The lithium iron phosphate cathode material was fit into the lithium iron phosphate half cell. Testing results show that the capacities were 151 mAh/g and 139 mAh/g at 1 C and 3 C respectively, and the capacity retention rate was, on average, over 98.5% after 120 cycles.

As shown in the example, despite the cheap raw materials used in the method and the simplicity of the method, the iron phosphate prepared has excellent capacity, rate-ability, cycling stability, and good comprehensive physical and chemical properties when used to manufacture lithium iron phosphate batteries.

1. A method for the preparation of iron phosphate, which is characterized by the following sequential steps:
(S1) mixing waste iron oxide and low purity iron powder and sulfuric acid in water, followed by the addition of phosphoric acid;
(S2) the addition of hydrogen peroxide to the resulting solution, followed by pH balancing chemicals to maintain a pH between 1.3 and 1.5;
(S3) the stirring of the resulting solution to precipitate iron (III) phosphate, followed by an aging step of the solution, a filtering step to extract the iron phosphate solid, a washing step of the solid, and a drying step of the solid to obtain iron phosphate, which may be in the form of a hydrate (ex. FePO₄·H₂O, FePO₄·2H₂O, FePO₄·3H₂O, etc.).

2. The method for the preparation of iron phosphate of claim 1, in which during step (S1), iron (II) sulfate or iron (III) sulfate or a combination thereof is also mixed into the initial solution, whereby less than 50% of the source of iron atoms is from these sulfate salts.

3. The method for the preparation of iron phosphate of claim 1, in which during step (S1), the iron oxide is mixed with low purity iron powder at a mass ratio of 2:98-98:2, whereby the iron powder is 10-95 um in size.

4. The method for the preparation of iron phosphate of claim 1, in which during step (S1), the mixing molar ratio of the iron oxide to sulfuric acid during the formation of the mixture solution is 1:2-3.

5. The method for the preparation of iron phosphate of claim 1, in which during step (S1), the mixing molar ratio of the iron oxide to phosphoric acid during the formation of the mixture solution is 1:2-3.

6. The method for the preparation of iron phosphate of claim 1, in which step (S1) is carried out under continual rapid stirring at 40-98° C. for 0.5-3 hrs.

7. The method for the preparation of iron phosphate of claim 1, in which, after step (S1) but prior to step (S2), a filtering step is conducted to extract insoluble iron oxide and then additional phosphoric acid or water is added into the filtrate to maintain a pH of 1.3-1.7; the filtrate is the “resulting solution” in step (S2).

8. The method for the preparation of iron phosphate of claim 1, in which during step (S2), the mixing molar ratio of the iron phosphate to hydrogen peroxide is 1:0.5-1.5.

9. The method for the preparation of iron phosphate of claim 1, in which during step (S2), the pH rebalancing chemical is ammonium hydroxide (NH₄OH), sodium carbonate (Na₂CO₃), sodium bicarbonate (NaHCO₃), or a combination thereof.

10. The method for the preparation of iron phosphate of claim 1, in which step (S2) is carried out under continual rapid stirring at 40-98° C. for 0.5-3 hrs.

11. The method for the preparation of iron phosphate of claim 1, in which during step (S3), the stirring step is carried out at 400-1200 rpm at 50-80° C. for 0.5-12 hrs.

12. The method for the preparation of iron phosphate of claim 1, in which during step (S3), during the aging step, the solution is aged for 10-12 hrs at 15-40° C.

13. The method for the preparation of iron phosphate of claim 1, in which during step (S3), during the drying step, the iron phosphate is dried at 120-300° C. for 1-12 hrs.

14. The method for the preparation of iron phosphate of claim 1, in which during step (S3), the solvent used for washing is water or ethanol or a combination thereof, hereby the mass ratio of iron phosphate solid to the solvent is 1:2-4.
